(19) United States
(12) Patent Application Publication
(10) Pub. No.: US 2022/0143973 A1
(43) Pub. Date: May 12, 2022

(54) PRINTERS AND CONTROLLERS

(71) Applicant: Hewlett-Packard Development Company, L.P., Spring, TX (US)

(72) Inventors: Alexandre Rodriguez Llofriu, Sant Cugat del Valles (ES); Diana Canto Estany, Sant Cugat del Valles (ES); Eduardo Amela Conesa, Sant Cugat del Valles (ES)

(73) Assignee: Hewlett-Packard Development Company, L.P., Spring, TX (US)

(21) Appl. No.: 17/418,961

(22) PCT Filed: Jul. 24, 2019
(86) PCT No.: PCT/US2019/043158

§ 371 Date: Jun. 28, 2021

(51) Int. Cl. B41J 2/045; B41J 2/18; B41J 2/14

(52) U.S. Cl. CPC B41J 2/04563; B41J 2/18; B41J 2002/14467; B41J 2002/14354; B41J 2/14

(57) ABSTRACT

Example implementations relate to controllers and printers to operate at least one liquid ejection device of a printhead; the liquid ejection device comprising a nozzle and an associated print liquid chamber bearing a transducer to eject print liquid from the nozzle in response to a firing signal; the print chamber being fluidically coupled to a nozzle supply channel; the at least one liquid ejection device comprising a channel coupled to the print liquid chamber and the nozzle supply channel; the channel having a respective actuator to urge print liquid through the print chamber in response to a circulation signal; wherein the controller comprises temperature control circuitry to actuate the respective actuator using a temperature control signal to increase the temperature of print liquid in the print liquid chamber.

### BACKGROUND

Inkjet printing mechanisms fire drops of ink onto a print medium to generate an image. Such mechanisms may be used in a wide variety of applications, including computer printers, plotters, copiers, and facsimile machines. An inkjet printing apparatus may include a printhead having a plurality of independently addressable firing units or liquid ejection devices. Each firing unit may include a liquid chamber connected to a liquid source and to a liquid outlet nozzle. A transducer within the liquid chamber provides the energy for firing drops of print liquid from the nozzles. In thermal inkjet printers, the transducers are thin-film resistors that generate sufficient heat, in response to a voltage pulse, to vaporize a quantity of liquid. The vaporization is sufficient to fire a drop of print liquid. However, repeated operation of the printhead can lead to image quality anomalies due to thermal issues such as, for example, an adverse temperature distribution associated with the printhead.

### BRIEF INTRODUCTION OF THE DRAWINGS

Example implementations are described below with reference to the accompanying drawings, in which:

FIG. 1 shows a schematic diagram of a printer according to some examples;

FIG. 2 illustrates schematically an apparatus of part of the printer of FIG. 1 according to some examples;

FIG. 3 depicts two liquid ejection devices according to example implementations;

FIG. 4 shows a flowchart according to example implementations;

FIG. 5 illustrates a number of signals according to example implementations;

FIG. 6 shows variations in temperature control signals with nozzle usage according to example implementations;

FIG. 7 shows a data structure according to example implementations; and

FIG. 8 depicts machine-readable storage and machine executable instructions according to some examples.

### DETAILED DESCRIPTION

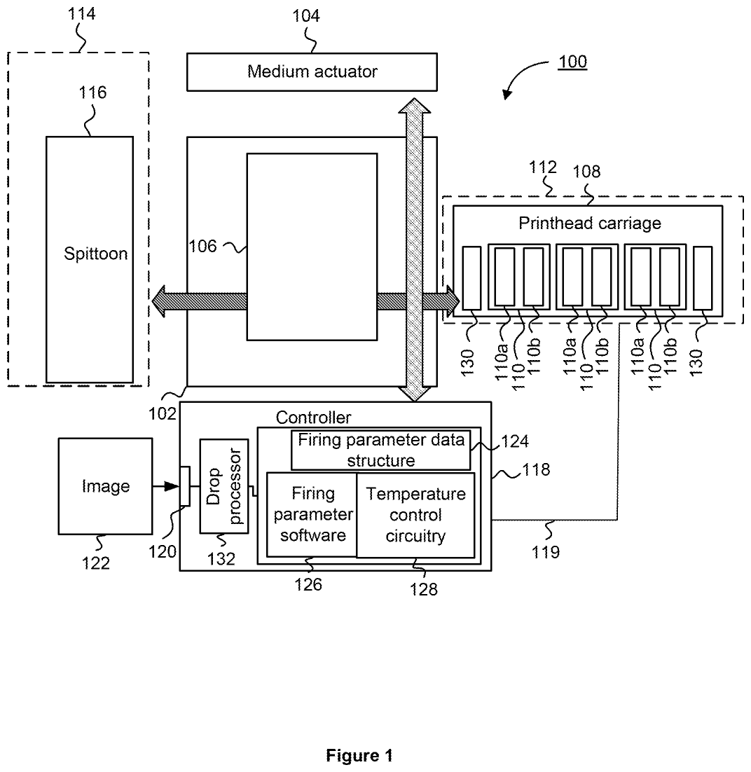

FIG. 1 illustrates a schematic view of a printer 100. The printer 100 comprises: a working area 102 in which a printed image can be produced. The working area is an example of a printing region. The printer 100 further comprises a medium actuator 104. The medium actuator 104 moves a medium 106 on which a printing liquid is to be deposited in between print traversals of a printhead carriage 108. A print traversal is a movement of the printhead carriage 108 from one side of the working area 102 to the other side of the working area.

The printhead carriage 108 comprises one or more than one printhead 110 for printing one or more than one drop of printing liquid. A printhead 110 can comprise one or more than one channel 110a, 110b for receiving and expelling printing liquid. One or more than one printhead 110 can optionally fire, that is, expel or eject, one or more than one printing liquid during a print traversal. Examples can be realised in which the printhead carriage 108 comprises a number of printheads 110. The printheads 110 are arranged to deposit respective drops of printing liquids onto the medium 106. The one or more than one printing liquids can comprise one or more printing liquids associated with a respective colour process. Such a colour process can comprise a single tone or multiple tones. For example, a six-colour process, involving magenta, yellow, cyan, red and two blacks, can be used. Similarly, a nine-colour process could be used. In the example shown, each printhead 110 contains two channels 110a, 110b for printing liquid. The example implementation shown uses a six-colour process with the colours being ejected from respective channels 110a, 110b of the three printheads 110. Examples can be realised in which a nine-colour process can be accommodated via five printheads. Each channel comprises a number of nozzles for ejecting drops of print liquid such as the above described inks or printing liquids.

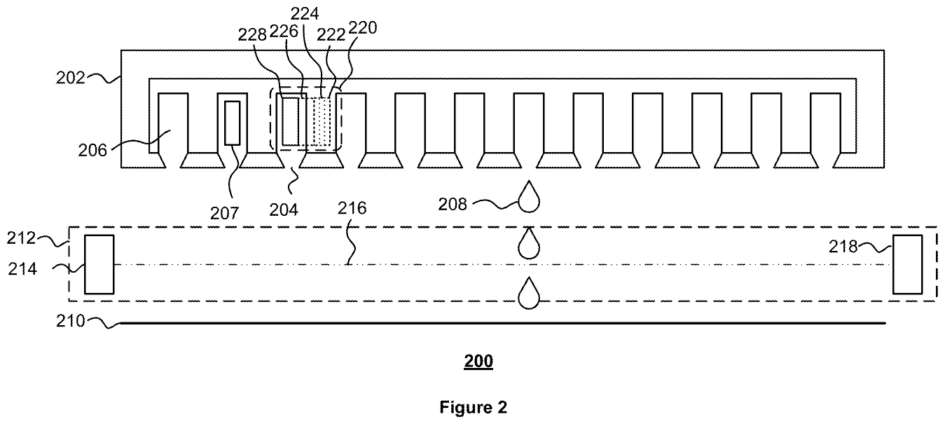

The printhead carriage 108, in this example, is arranged to traverse the working area 102 in a reciprocating manner. While traversing the working area 102, the printheads 108 can print printing liquids onto the medium 106. The printheads can deposit printing liquid onto the medium 106 in either one direction or both directions of traversal. The printheads 110 can use an array of nozzles, described with reference to FIG. 2, to deposit the printing liquids. Depositing the printing liquids can use a thermal technique in which a transducer such as, for example, a heating element is arranged to heat the printing liquid rapidly so that printing liquid is ejected from a nozzle associated with the heating element.

Although the example implementations described herein use a moveable printhead carriage 108, examples are not limited to such an arrangement. Example implementations can be realised that are page-wide printers that do not use a carriage due to the printheads spanning the full width of the working area 102.

A stowage area 112 can be optionally provided to one side of the working area 102. The printhead carriage 108 can be stowed in the stowage area 112 between printing traversals.

A maintenance area 114 can be provided to the side of the working area 102. The maintenance area 114 is an example of a maintenance region. The maintenance area 114 can comprise a spittoon 116 for receiving one or more than one printing liquid during one or a number of maintenance operations.

A controller 118 is provided for controlling one or more aspects of the printer and/or printer operations such as, for example, at least one, or both of, printing operations or maintenance operations. The controller 118 can comprise an input interface 120 for receiving an image 122 to be printed. The controller 118 is operable to print an image by firing appropriate nozzles of the channels 110a, 110b of the printheads 110. The nozzles are fired in response to respective firing parameter data stored within a data structure 124 of, or accessible by, the controller 118.

The controller 118 is also operable to change or otherwise modify the energy applied to the heaters or transducers to produce drops of print liquid. For example, the controller 118 comprises circuitry or software 126 to vary, such as, for example, reduce or increase, the at least one firing parameter of each of the nozzles to prolong the life of the print head as described herein. Example implementations can be realised in which the energy applied to the transducer to eject a drop of print liquid is an OverEnergy operational parameter, which is described below. The transducer, the liquid chamber and nozzle constitute, or constitute at least part of, a liquid ejection device. The controller 118 can control the printer or parts of the printer such as, for example, the printhead or any associated transducers as described herein, using an associated bus 119.

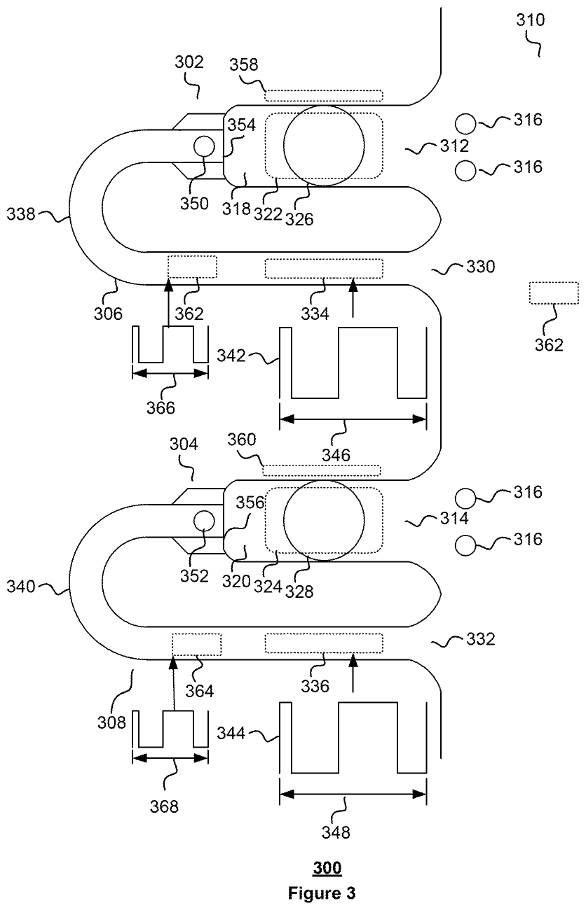

Furthermore, example implementations can additionally comprise temperature control circuitry or software 128 that can produce at least one temperature control signal or a number of temperature control signals that are associated with, or that influence, the temperature of print liquid within a liquid chamber of such a liquid ejection device, which are described below with reference to FIGS. 2 and 3. Example implementations of the circuitry or software 126, 128 can modify, or be responsive to, the parameters stored within the data structure 124. The data structure 124 can comprise such a temperature control signal or such a number of temperature control signals that heat, or pre-heat, the print liquid. Heating, or pre-heating, print liquid can be undertaken by recirculating print liquid as described below with reference to at least one, or both, of FIG. 2 or 3. Each liquid ejection device can have a respective temperature control signal. The number of temperature control signals can be the same or can be different.

The printheads can have an associated drop detector 130, or respective drop detectors, that is, or are, arranged to determine at least one characteristic of a drop of printing liquid ejected from a nozzle of such a liquid ejection device. The drop detector can determine at least one of drop velocity, drop mass or any other drop feature of a drop or drops ejected from a nozzle. The data generated by the drop detector 130 is processed by a drop data processor 132 to determine the at least one characteristic of, or associated with, a drop ejected from a nozzle.

FIG. 2 shows schematically an example of parts of an apparatus 200 of the printer 100 of FIG. 1. In this example, the apparatus 200 comprises a plurality of inkjet print heads 202. In other examples, the apparatus 200 may comprise one printhead.

The inkjet printhead 202 comprises a plurality of nozzles 204 in this example. A printhead may comprise, for example, over a thousand nozzles per printhead. Each nozzle can be arranged to fire at least one drop of a print liquid. Examples of a print liquid comprise, for example, an ink or a pre-treatment liquid. Each nozzle is 204 is connected to a respective liquid chamber 206. A liquid chamber 206 receives liquid from a liquid source (not shown). Each liquid chamber 206 can be connected to a separate liquid source or can be connected to a common liquid source. Such a liquid source can comprise, for example, a reservoir storing an ink, or a pre-treatment liquid as indicated above.

Each liquid chamber 206 can comprise a transducer 207. The transducer is an example of the above described transducer or transducers for providing energy to eject liquid from a liquid ejection device. Only a single transducer 207 is shown for clarity purposes even though all chambers comprise a respective transducer. Example implementations of a transducer comprise a thin film heater such as, for example, a thin film resistor, for heating the liquid in the liquid chamber 206. Alternatively, a transducer can comprise a Piezo electric transducer. To print liquid, liquid is transferred from the liquid source or liquid reservoir into the liquid chamber 206 and an actuation or firing signal is applied to the transducer, which creates a pressure pulse in the liquid in the chamber 206 that, in turn, causes a drop 208 of print liquid to be fired from a respective nozzle 204 coupled to the chamber. The drop 208 of print liquid is directed to a print medium 210. The print medium can comprise, for example, paper or some other medium. The print medium and other medium are examples of a substrate. The print medium 210 is an example of the above described print medium 106.

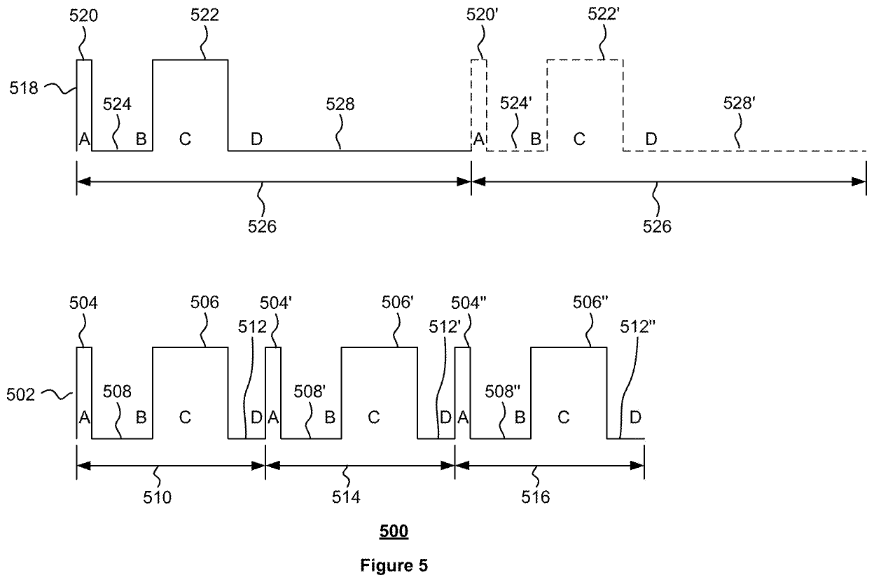

The signal can take the form of, for example, a voltage pulse or signal having predetermined characteristics such as signal, magnitude, duration and frequency. An example of a firing signal is described below with reference to FIG. 5.

Alternatively, or additionally, a series of such voltage pulses or such signals can be applied to a transducer at a certain frequency. Such a frequency is known as the firing frequency. The series of such voltage pulses or such signals can be arranged to fire at least one drop 208 of print liquid from the printhead at the firing frequency. By controlling the width and amplitude, duty cycle, or energy, of each voltage pulse, the quantity of liquid in each fired drop of print liquid can be controlled. For example, increasing the amplitude or width of an applied voltage pulse can influence at least one, or both, of drop mass or drop velocity of a drop 208 of print liquid ejected from a nozzle 204.

The printing apparatus shown in FIG. 2 can also comprises a drop detector 212. The drop detector 212 is an example of the above-described drop detector 130. The drop detector 212 is arranged to measure a characteristic of, or associated with, at least one drop 208 of print liquid fired by the printhead 202. The drop detector may, for example, comprise a light source 214 for producing, for example, a collimated beam of light 216. The beam of light 216 can be detected by a detector 218. Example implementations can be realised in which the detector 218 is a photodetector. The light source 214 and the detector 218 are separated to allow drops of print liquid fired from the nozzles to cross the light beam 216. Drops of print liquid crossing the light beam 216 will influence the light incident upon the detector 218. The difference between an uninterrupted beam of light 216 and an interrupted beam of light is associated with one or more than one parameter or characteristic of, or associated with, the drops 208 of print liquid. One or more than one drop of print liquid can, for example, absorb and/or scatter light thereby influencing the amount of light incident upon the photodetector 218. The one or more than one parameter of the drop of print liquid can comprise at least one or more than one of drop velocity, drop mass, or drop position taken jointly and severally in any and all permutations.

Repeated operation of the transducers 207 can cause the temperature of the printhead, or the region, or regions, of the printhead adjacent to the transducer 207, to increase. The temperature of the liquid to be fired can influence the performance of the nozzle or printhead. As indicated above, such regional or local heating can lead to temperature variations across a printhead that can lead to image quality anomalies such as, for example, banding or other anomalies.

Still further, over the lifetime of the printhead, at least one, or both, of the drop velocity or the quantity/volume of print liquid ejected from the printhead for a given voltage pulse at a certain firing frequency may change. This follows as a consequence of, for example, liquid residues accumulating in the liquid chamber 206 of the printhead, which thereby reduces the quantity of print liquid ejected from the printhead by obstructing the path of the print liquid from the liquid chamber 206 through the nozzle 204. Furthermore, for example, thin-film heaters, such as thin film resistors controlling drop production within the printhead, may wear out thereby affecting the quantity of print liquid ejected additionally, or alternatively, due to a process called kogation, a scale may form on the resistor that separates the liquid from the resistor such that irregular print liquid ejection occurs.

Therefore, example implementations can be realised in which the following parameters associated with printing or firing a drop of print liquid can be adapted to extend the operational life of the printhead. One such parameter is the Turn-On-Energy (TOE), which is an indication of the amount of energy delivered to a transducer, such as, for example, the above described heater 206, to eject a drop of print liquid. Another such parameter is the OverEnergy (OE) factor, which, in conjunction with the TOE, is an indicator of the energy delivered to such a transducer to eject, or otherwise fire, a drop of print liquid. The OverEnergy factor is a multiplier that is applied to the Turn-On-Energy.

Also shown in FIG. 2 is a recirculation pump 220. The recirculation pump 220, which can also be known as a micro-recirculation pump, is arranged to circulate print liquid from a print liquid supply channel (shown in, and described with reference to, FIG. 3) into, or through, the liquid chamber 206. The recirculation pump 220 comprises a recirculation chamber 222 comprising a recirculation transducer 224. The recirculation transducer can be a heater such as, or similar to, the above transducer 207. The recirculation chamber 222 is coupled to the liquid chamber 206 via a recirculation channel 226 that provides a fluidic coupling to a recirculation aperture 228 of the liquid chamber 206. Although not shown in FIG. 1, the controller can additionally comprise circulation circuitry or circulation software for controlling the recirculation pump 220.

FIG. 3 shows a view 300 of first and second liquid ejection devices 302 and 304 together with respective recirculation pumps 306 and 308. The liquid ejection devices 302 and 304 are examples of any liquid ejection device described herein. The recirculation pumps 306 and 308 are examples of any recirculation pump described herein. The liquid ejection devices 302 and 304 are coupled to a liquid supply channel 310. The liquid supply channel 310 receives liquid from, for example, the above described liquid reservoir. Liquid within the liquid supply channel 310 is drawn into the liquid ejection devices 302 and 304 via respective apertures 312 and 314. One or more than one filter 316 is provided to prevent debris or particles from entering liquid chambers 318 and 320 of the liquid ejection devices 302 and 304. Each liquid chamber 318 and 320 comprises a respective transducer 322 and 324 for ejecting liquid from respective nozzles 326 and 328. The transducers 326 and 328 are examples of the above described transducers 207 or any other transducer described herein for ejecting liquid from a respective nozzle.

Each recirculation pump 306 and 308 comprises an inlet aperture 330 and 332 for drawing liquid from the liquid supply channel 310. Further respective transducers 334 and 336 are provided within respective liquid recirculation channels 338 and 340. The further respective transducers 334 and 336 are arranged to influence the temperature of the ink within the liquid ejection devices 302 and 304. Example implementations are provided in which the respective transducers 334 and 336 can be, or are, arranged to increase the temperature of the liquid in the liquid ejection devices. The further respective transducers 334 and 336 are responsive to one or more than one respective temperature control signal 342 and 344. A single period or cycle 346 and 348 is shown for each temperature control signal 342 and 344. The temperature control signals 346 and 348 are described in greater detail below with reference to FIG. 5.

Exciting or otherwise actuating the further respective transducers 334 and 336 using one or more than one respective temperature control signal 342 and 344 serves the purpose of at least one, or both, of heating the liquid drawn from the liquid supply channel 310 so that the temperature of the liquid within the liquid chambers 318 and 320 can be influenced or controlled or simply recirculating or otherwise replacing the liquid in the liquid chambers 318 and 320. Actuating one or more than one of the transducers 334 and 336 comprises applying a temperature control signal to the one or more than one of the transducers 334 and 336.

Therefore, it can be appreciated that a difference in temperature between the one liquid ejection device 302 and the other liquid ejection device 304 can be controlled by using one or more than one of, or at least one, or both, of the temperature control signals 342 and 344 to influence the temperature of the liquid in one or more than one of the liquid chambers 318 and 320.

The one or more than one transducer 334 and 336 can be subjected to a respective temperature control signal until a predetermined condition or criterion is met. The predetermined condition or criterion can comprise a temperature difference between the two liquid ejection devices 302 and 304 being within a predetermined tolerance. Such a predetermined tolerance can be a tolerance at which image quality issues, such as, for example, banding, are at least reduced or eliminated. The predetermined tolerance can comprise a predetermined temperature difference between the two liquid ejection devices.

The predetermined criterion can, additionally or alternatively, comprise subjecting one or more of the further respective transducers 334 and 336 of the recirculation pumps 306 and 308 to one or more than one respective temperature control signal 342 and 344 for at least one, or both, of a predetermined period of time or a predetermined number of cycles 346 and 348 of the one or more than one respective temperature control signal 342 and 344.

Example implementations can be realised in which the liquid recirculation channels 338 and 340 comprise respective filters 350 and 352. The filters 350 and 352 can take the form of columns or pillars, or some other form such as, for example, a mesh. The filters 350 and 352 can be disposed at respective apertures 354 and 356 into the liquid chambers 318 and 320.

Although example implementations have been described with reference to controlling the temperature of adjacent liquid ejection devices 302 and 304 through recirculation, example implementations can be realised in which the temperatures of non-adjacent, or otherwise spaced apart, liquid ejection devices are controlled though such recirculation.

Furthermore, rather than determining the temperature of the liquid chamber in determining whether or not to instigate recirculation to control temperature, example implementations can be realised in which the circulation is response to at least one other condition or criterion. Examples of such at least one condition or criterion comprise, for example, one or more than one of a predetermined number of fires or liquid ejections, that is, activity levels of one or more than one liquid ejection device or a predetermined frequency, or predetermined period, of firing, all taken jointly and severally in any and all permutations.

Still further, although example implementations have been described with reference to controlling the two liquid ejection devices 302 and 304 individually, example implementations can be realised in which sets of liquid ejection devices are controlled. A set of liquid ejection devices can comprise one or a number of liquid ejection devices. The temperature of such spaced apart liquid injection devices is controlled by applying a temperature control signal to at least one, or more than one, of the liquid injection devices having temperatures that need to be equalised relative to the temperatures of other liquid ejection devices. The other liquid ejection devices can be either adjacent to the one or more than one liquid ejection device having a temperature to be controlled or spaced apart from the one or more than liquid ejection device having a temperature to be controlled.

Yet further, although example implementations have described as controlling the liquid ejection devices in response to at least one or more than one condition or at least a criterion or criteria associated with at least one, or both, of the liquid ejection devices, example implementations can be realised in which the control is responsive to at least one or more than one condition or at least a criterion or criteria associated with a set of liquid ejection devices. Such a set of liquid ejection devices can comprise one or a number of liquid ejection devices. Such a set of liquid ejection devices can comprise adjacent or non-adjacent liquid ejection devices.

Similarly, the example implementations can be realised in which the controller is responsive to at least one or more than one condition or criterion or criteria associated with at least one liquid ejection device to control a parameter associated with one liquid ejection device or a number of liquid ejection devices. It can be appreciated that the stimulus and control response is a one to many response.

Example implementations can be realised in which the controller is responsive to a set of parameters or characteristics associated with a set of liquid ejection devices to control a set of parameters or characteristics associated with a set of liquid ejection device. A set of parameters or characteristics associated with a set of liquid ejection devices can comprise one or more than one parameter or characteristic. A set of liquid ejection devices can comprise one or more than one liquid ejection device. The one or more than one parameter or characteristic can comprise one or more than one of temperature, an activity measure, a usage measure such as, for example, number of firing actuations, duration of firing, elapsed time since firing, elapsed time since firing at a predetermined frequency or for a predetermined duration, all taken jointly and severally in any and all permutations.

Each liquid chamber 318 and 320 can additionally have one or more than one temperature sensor for determining the temperature of the printhead in the region of a respective liquid chamber 318 and 320. In the example shown, each liquid chamber 318 and 320 has a respective temperature sensor 358 and 360. Suitably, the controller can be responsive to one or more than one temperature associated with at least one or more than one respective liquid ejection device, or a set of such liquid ejection devices in applying or otherwise outputting at least one or more than one temperature control signal to such a liquid ejection device or to such a set of liquid ejection devices.

Although the example implementations have been described as heating the liquid in the recirculation channels 338 and 340 using the transducers 334 and 336, example implementations are not limited to such arrangements. Example implementations can be realised in which suitably heated liquid is circulated when actuating at least one, or both, of the transducers 334 and 336. For example, example implementations can be realised in which one or more than one circulation channel 338 or 340 comprises a heater to heat the liquid prior to that liquid being circulated via the transducers 334 or 336 into the print chambers 318 and 320. Suitably, FIG. 3 shows such additional or separate heaters 362 and 364. Example implementations using such additional or separate heaters 362 and 364 within the recirculation channels 338 and 340 may use any form of temperature control signal 366 or 368 for increasing the temperature of the liquid within the recirculation channels 338 and 340 concurrently with or timed relative to the transducers 334 and 336 being actuated to circulate the liquid. For example, the liquid adjacent to a heater 362 or 364 to be heated can be heated using a respective temperature control signal 366 or 368 a predetermined period of time in advance of that liquid being circulated. In the example depicted the temperature control signals 366 and 368 for the additional or separate heaters 362 and 364 are the same as, or are similar to, the signals 346 and 348 applied to the transducers 334 and 336, but could equally well be some other form of signal.

It will be appreciated that transducers 334 and 336 can also operate to implement or realise the above described pump 220. Accordingly, the controller 118 can realise or implement at least one, or both, of circulation or heating of the liquid in at least one, or both, of the circulation channels 338 or 340 using the same circuitry or software or using separate, respective, circuitry or software.

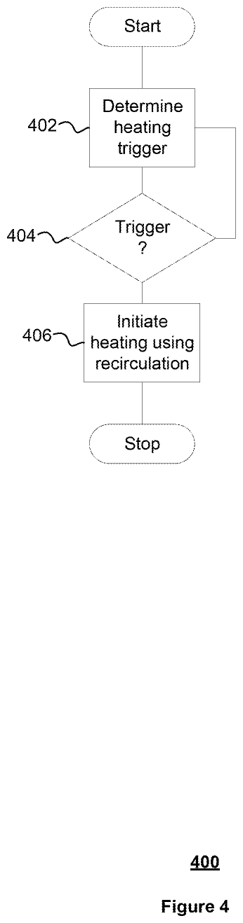

Referring to FIG. 4, there is shown a flowchart 400 according to an example implementation for controlling temperature distribution within a printhead. At 402, a heating trigger is investigated. A heating trigger is a parameter or characteristic of, or associated with, a printhead, or a set of liquid ejection devices. Such a set of liquid ejection devices has been described above. Such a set may comprise one or more than one liquid ejection device. In example implementations, the set may comprise a plurality of liquid ejection devices. The plurality of liquid ejection devices can comprise at least one of adjacent liquid ejection devices, non-adjacent liquid ejection devices or a combination of adjacent and non-adjacent liquid ejection devices. At 404, a determination is made regarding whether or not the controller 118 needs to take action to address actual or anticipated heat distribution across a printhead or such a set of liquid ejection devices in response to the heating trigger. At 406, heating is initiated using a temperature control signal such as the above-described temperature control signals. The temperature control signal is applied to a transducer for recirculating liquid to control the temperature of at least one or more than one liquid ejection device as describe above. The transducer can be any temperature controlling transducer such as, for example, the above-described transducers 334 or 336.

Referring FIG. 5, there is shown a view 500 of a pair of signals according to example implementations. A first signal 502 is an example implementation of a temperature control signal such as, for example, the above-described temperature control signals. The temperature control signal 502 has a predetermined profile. The temperature control signal 502 can comprise one or more than one pulse. In the example implementation depicted, the temperature control signal 502 comprises a plurality of pulses. The plurality of pulses can comprise at least one, or both, of a precursor pulse 504 and a heating pulse 506. The precursor pulse 504 and the heating pulse 506 are separated by a lower level portion of the signal. In the example depicted, the lower level portion of the signal comprises a so-called dead time portion 508. The dead time portion 508 has can have an amplitude of zero such that energy is not applied to the recirculation transducer during the dead time portion 508. Although example implementations of the temperature control signals described herein comprise at least one, or both, of a precursor pulse and a dead time portion, example implementations can be realised without at least one, or both, of such a precursor pulse and such a dead time portion.

The temperature control signal 502 has a predetermined period or duration 510. The remainder 512 of the predetermined period or duration 510 of the temperature control signal 502 comprises a lower level portion of the signal. In the example depicted, the lower level portion of the signal can have an amplitude of zero, or some other amplitude. Example implementations can be realised in which a plurality of periods of the temperature control signal are applied to the recirculation transducer to control, or otherwise increase, the temperature of an associated liquid ejection device. The example implementation depicted comprises three periods 510, 514 and 516.

Although example implementations of the temperature control signal 502 have been described with reference to using three periods 510, 514, 516, implementations are not limited to such an arrangement. Example implementations can be realised in which one such period is used, or a plurality of such periods are used, to form the temperature control signal 502. Still further, where a plurality of periods is used to form the temperature control signal 502, the periods can be contiguously disposed or noncontiguously disposed.

The various portions of the temperature control signal 502 can have predetermined ratios. Example implementations can be realised in which the predetermined ratios are A:B:C:D. An example implementation can be realised in which the predetermined ratios can be A:B:C=1:3:3, with the remainder D being dependent on the frequency. Example implementations can be realised in which the frequency is of the order of several kilohertz such as, for example, 20 kHz to 40 kHz such as, for example, 33 kHz. Example implementations can be realised in which the frequency is up to 36 kHz. Example implementations can be realised in which

portion A has a predetermined duration such as, for example, 257 ns,

portion B has a predetermined duration such as, for example, 600 ns,

portion C has a predetermined duration such as, for example, 600 ns.

A second signal 518 is an example implementation of a firing signal for causing a liquid ejection device to eject a liquid within a corresponding liquid chamber via a respective nozzle. The firing signal 518 has a predetermined profile. The firing signal 518 can comprise one or more than one pulse. In the example implementation depicted, the firing signal 518 comprises a plurality of pulses. The plurality of pulses can comprise at least one, or both, of a precursor pulse 520 and a heating pulse 522. The precursor pulse 520 and the heating pulse 522 are separated by a lower level portion of the signal. In the example depicted, the lower level portion of the signal comprises a so-called dead time portion 524. The dead time portion 524 has can have an amplitude of zero such that energy is not applied to the firing transducer during the dead time portion 524. The dead time is provided to allow the effects of pre-heating the liquid using the precursor pulse to stabilise, since the precursor pulse can induce unwanted motion of the liquid prior to ejection. Such unwanted motion can adversely affect image quality.

The firing signal 518 has a predetermined period or duration 526. The remainder 528 of the predetermined period or duration 526 of the firing signal 518 comprises a lower level portion of the signal. In the example depicted, the lower level portion of the signal can have an amplitude of zero, or some other amplitude. Example implementations can be realised in which a plurality of periods of the firing signal are applied to the firing transducer according to at least one, or both, of substrate or medium coverage due to an image to be printed or image quality of an image to be printed. The example implementation depicted comprises an additional period 530 shown in dashed line form. Where a plurality of periods is used to form the firing signal 518, the periods can be contiguously disposed or noncontiguously disposed.

The various portions of the firing signal 518 can have predetermined ratios. Example implementations can be realised in which the predetermined ratios are A:B:C:D. An example implementation can be realised in which the predetermined ratios can be A:B:C=1:3:3, with the remainder D being dependent on the frequency. Example implementations can be realised in which the frequency is of the order of several kilohertz such as, for example, 5 kHz to 15 Hz such as, for example, 9 Hz. Example implementations can be realised in which

portion A has a predetermined duration such as, for example, 257 ns,

portion B has a predetermined duration such as, for example, 600 ns,

portion C has a predetermined duration such as, for example, 600 ns.

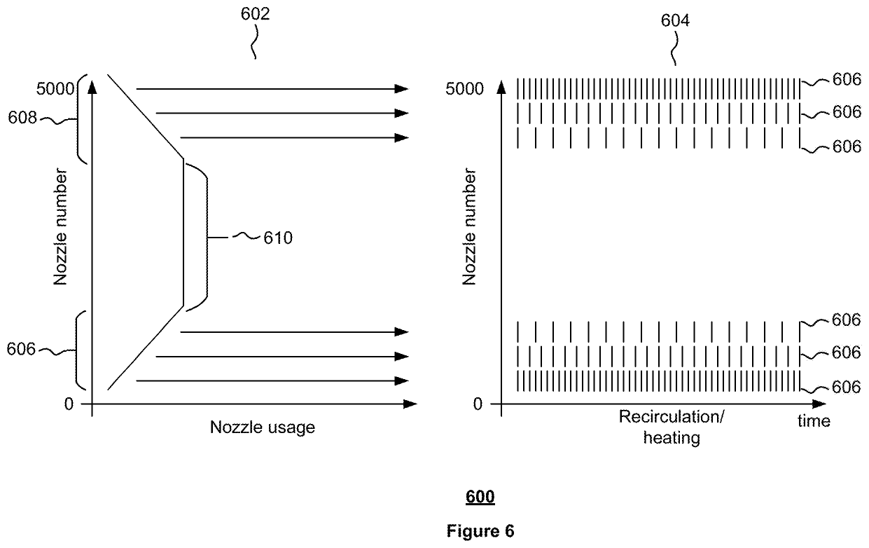

Referring to FIG. 6, there is shown a view 600 of a pair of graphs 602 and 604 used in controlling the temperature of a printhead (not shown). The printhead can be any printhead described or claims herein. A first graph 602 shows the variation in nozzle usage over a predetermined period of time. An assumption is made that nozzle usage is correlated with nozzle temperature. Therefore, it can be appreciated that the outmost sets of nozzles 606 and 608 have been used the least, with usage progressively rising towards a maximum for a central group or set of nozzles 610. It will be appreciated that the distribution of nozzle usage has been shown to have a trapezoidal distribution for the purpose of illustration only. Actual usage will be more distributed such that, in turn, the temperature variation across the printhead will be more varied.

The central group or set of nozzles 610 will have, can be assumed to have, or will have been measured as having, a respective temperature. The outer groups or sets of nozzles 606 and 608 will have, can be assumed to have, or will have been measured as having, respective temperatures. The respective temperatures of the outer groups or sets of nozzles 606 and 608 are lower than the respective temperature of the central group or set of nozzles 610. To avoid, or at least mitigate, the effects of an uneven temperature distribution across one or more than one liquid ejection devices associated with the lower temperature/lower usage nozzles or the lower temperature/lower usage sets or groups of nozzles 606 and 608 are activated, or otherwise actuated, using respective temperature control signals such as any temperature control signal described herein to influence the temperature in the region or locality of those lower usage/lower temperature nozzles to make them the same temperature as the nozzles in the central set or group of nozzles 610, or to bring them to within a predetermined temperature tolerance of the central set or group of nozzles 610.

Referring to the second graph 604, there is shown the recirculation heating response to the nozzle usage distribution or nozzle temperature distribution. It can be appreciated that the nozzles having the least use, that is, those nozzles in the uppermost and lowermost portions of regions 606 and 608 have an appropriately frequency of temperature control signal 612 to make the temperature of the corresponding nozzles the same as that of the nozzles of the central region. The nozzles in the penultimate or middle portions of regions 606 and 608 have higher usage or temperature and can there have an appropriately lower frequency of temperature control signal 614 to make the temperature of the corresponding nozzles the same as that of the nozzles of the central region. Similarly, the nozzles in the antepenultimate or innermost portions of regions 606 and 608 have a still higher usage or temperature and can there have an appropriately still lower frequency of temperature control signal 616 to make the temperature of the corresponding nozzles the same as that of the nozzles of the central region.

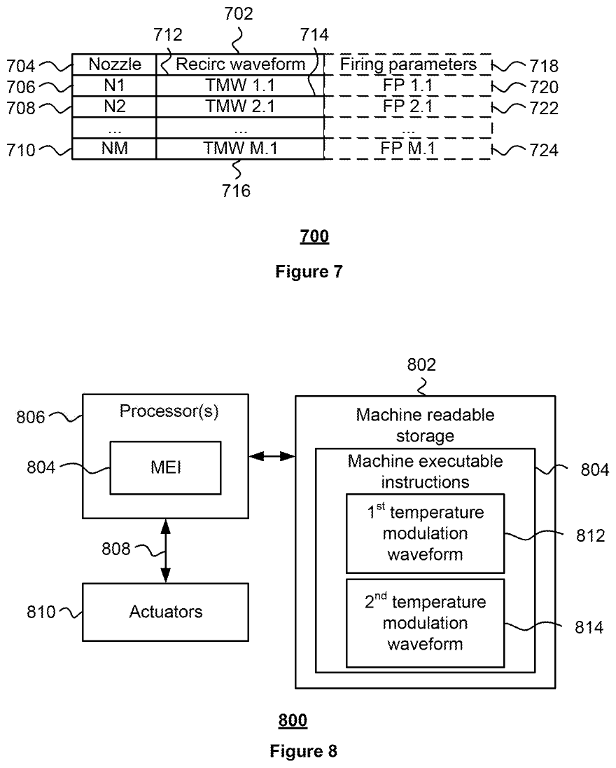

Referring to FIG. 7, there is shown a view of a data structure 700 for storing at least one set of parameters associated with, or for constructing, a corresponding temperature control signal 702 associated with a nozzle 704 of a printhead. The data structure 700 comprises a number 706 to 710 of entries corresponding addressable nozzles of the printhead, that is, nozzles numbered 1 to M. In the example depicted in FIG. 6, m=4999. Each nozzle has at least one set of such parameters 712 to 716 associated with, or for constructing, a corresponding temperature control signal. The set of parameters 712 to 716 are used to influence the recirculation pumps of respective nozzles or liquid ejection devices to vary the temperature in the region of those respective nozzles or liquid ejection devices. The parameters can comprise, for example, one or more than one parameter defining a temperature control signal such as, for example, the temperature control signal described above with reference to FIG. 5. Example implementations can be realised in which the parameters comprise at least one or more than one of precursor pulse width, deadtime duration, heating or recirculation pulse width or frequency, taken jointly and severally in any and all permutations.

The data structure 700 can optionally comprise a set 718 of firing parameters 720 to 724 that influence a characteristic of a drop of print liquid ejected from a respective nozzle. The further set of firing parameters 718 can comprise, for example, nozzle temperature, chamber 206 temperature or print liquid temperature, taken jointly and severally in any and all permutations, which, as indicated above, influence formation of the drop of print liquid.

The data structure 702 can be stored by the printer 100 and used by the controller 118 in managing or otherwise influencing at least one of the temperatures of the nozzles or liquid ejection devices of a printhead or firing the nozzles of the printhead channels 110a, 110b while printing and/or periodically testing the performance of the nozzles.

Example implementations can be realised in the form of machine executable instructions arranged, when executed by a machine, to implement any or all aspects, processes, activities or flowcharts, taken jointly and severally in any and all permutations, described in this application. Therefore, implementations also provide machine-readable storage storing such machine executable instructions. The machine-readable storage can comprise non-transitory machine-readable storage. The machine can comprise one or more processors or other circuitry for executing the instructions. For example, the controller 118 can process any such machine executable instructions or circuitry such as, for example, at least one, or both, of the above described software or circuitry 126 or 128.

Referring to FIG. 8, there is shown a view 800 of implementations of at least one of machine executable instructions or machine-readable storage. FIG. 8 shows machine-readable storage 802. The machine-readable storage 802 can be realised using any type of volatile or non-volatile storage such as, for example, memory, a ROM, RAM, EEPROM, optical storage and the like. The machine-readable storage 802 can be transitory or non-transitory. The machine-readable storage 802 stores machine executable instructions (MEIs) 804. The MEIs 804 comprise instructions that are executable by a processor or other instruction execution circuitry 806. The processor or other circuitry 806 is responsive to executing the MEIs 804 to perform any and all activities, operations, methods described and claimed in this application. It will be appreciated that the term circuitry comprises at least one, or both, of software or hardware. Software comprises such machine-readable and machine-executable instructions.

The processor or other circuitry 806 can output control signals 808 for influencing the operation of one or more than one actuator 810 for performing any and all operations, activities or methods described and claimed in this application. The actuators 810 can comprise, for example, the transducers 207, 334, 336 described managing the temperature of the nozzles or liquid ejection devices to ensure that they are the same or to ensure that they are within predetermined tolerances of one another.

The controller 118 can be an implementation of the foregoing processor or other circuitry 806 for executing any such MEIs 804.

The MEIs 804 can comprise, for example, at least one, or both, of instructions for varying, such as, for example, varying the temperature control signals as described and/or as claimed in this application, as can be appreciated from instructions 812, and/or instructions for varying, such as, for example, increasing, the temperature control signal parameters as described and/or as claimed in this application, as can be appreciated from instructions 814.

Suitably, executing such MEIs 804 realises the examples and example implementations described and/or claimed herein.

Any and all example implementations can be realised with or within a printer such as the printer described with reference to FIG. 1. The printer can be a multipass printer that is capable of printing at least one, or both, of bidirectionally or unidirectionally.

Although the above implementations have been described within a thermal inkjet (TIJ) printing context, example implementations are not limited to such a technology. Any and all example implementations can be used for controlling printheads realised using technology other than TIJ technology such as, for example, piezoelectric print heads.

It will be appreciated the example implementations can be realised using page-wide printheads. Some printers have one or more than one print head that spans the medium to be printed. Such printers are known as page-wide arrays. Page-wide array printers can have static print heads, that is, the carriage bearing the print heads does not traverse the medium rather the medium moves relative to the one or more than one print head.

Example implementations can be realised in which the firing parameters are tested and changed periodically, or in response to a predetermined event such as, for example, change of a pen.

Example implementations can be realised according to the following clauses:

Clause 1: A controller to operate at least one liquid ejection device of a printhead; the liquid ejection device comprising a nozzle and an associated print liquid chamber bearing a transducer to eject print liquid from the nozzle in response to a firing signal; the print chamber being fluidically coupled to a nozzle supply channel; the at least one liquid ejection device comprising a channel coupled to the print liquid chamber and the nozzle supply channel; the channel having a respective actuator to urge print liquid through the print chamber in response to a circulation signal; wherein the controller comprises temperature control circuitry to actuate the respective actuator using a temperature control signal to increase the temperature of print liquid in the print liquid chamber.

Clause 2: The controller of clause 1 in which the temperature control circuitry is responsive to detecting or monitoring at least one characteristic associated with the at least one liquid ejection device to output the temperature control signal to increase the temperature of the print liquid in the print liquid chamber of the at least one liquid ejection device.

Clause 3: The controller of clause 2 in which the least one respective characteristic associated with the at least one liquid ejection device comprises one or more than one of temperature, number of firings of the at least one liquid ejection device, firing frequency of the at least one liquid ejection device, firing duration of the at least one liquid ejection device, firing power of the at least one liquid ejection device, elapsed time since last firing of the at least one liquid ejection device, or an elapsed time since the at least one liquid ejection device last fired a predetermined number of times, taken jointly and severally in any and all permutations.

Clause 4: The controller of any preceding clause comprising circulation circuitry to output the circulation signal to the respective actuator of the at least one liquid ejection device.

Clause 5: The controller of any preceding clause comprising circuitry to output a further temperature control signal to a respective transducer associated with a further liquid ejection device.

Clause 6: The controller of clause 5 in which said temperature control signal is different to said further temperature control signal.

Clause 7: The controller of clause 6 in which said temperature control signal and said further temperature control signal comprise different corresponding characteristics.

Clause 8: The controller of clause 7 in which said different corresponding characteristics comprise one or more than one of temperature, number of firings of the at least one liquid ejection device, firing frequency of the at least one liquid ejection device, firing duration of the at least one liquid ejection device, firing power of the at least one liquid ejection device, elapsed time since last firing of the at least one liquid ejection device, or an elapsed time since the at least one liquid ejection device last fired a predetermined number of times, taken jointly and severally in any and all permutations.

Clause 9: The controller of any preceding clause comprising sensor circuitry to receive at least one signal from a sensor associated with detecting or monitoring at least one characteristic associated with the at least one liquid ejection device.

Clause 10: The controller of clause 9, comprising sensor circuitry to receive at least one further signal from a further sensor associated with detecting or monitoring at least one characteristic associated with at least one further liquid ejection device.

Clause 11: The controller of either of clauses 9 and 10, in which said one, or both, of the at least one signal and said at least one further signal are associated with a plurality of liquid ejection devices.

Clause 12: The controller of any preceding clause comprising circuitry to output an ejection signal to said transducer of said liquid ejection device.

Clause 13: The controller of any preceding clause in which the temperature control signal comprises one or more than one of a predefined signal, a pulse modulated signal, a predetermined frequency, a predetermined number of pulses, a predetermined pulse width, or first and second pulses taken jointly and severally in any and all permutations.

Clause 14: A printer comprising a controller of any preceding clause.

Clause 15: A printer comprising: a print liquid chamber bearing a transducer to eject print liquid from a nozzle in response to a firing signal, a recirculation pump having a recirculation channel with a respective actuator to urge print liquid into the print chamber in response to a circulation signal; and a controller having temperature control circuitry to output at least one temperature control signal to the respective actuator to increase the temperature of the print liquid urged into the print chamber.

Clause 16: A method of controlling temperature of liquid in a liquid chamber of a printer comprising a liquid ejection device of a printhead; the printhead comprising a circulation channel, coupled between the liquid chamber and a liquid supply channel, to supply liquid to the liquid chamber in response to actuating a circulation channel actuator using a respective circulation signal; the method comprising heating liquid in the circulation channel before supplying the heated liquid to the liquid chamber.

Clause 17: The method of clause 16 comprising actuating the respective actuator using a temperature control signal to increase the temperature of print liquid in the print liquid chamber.

Clause 18: The method of clause 17 comprising detecting or monitoring at least one characteristic associated with the at least one liquid ejection device to output the temperature control signal to increase the temperature of the print liquid in the print liquid chamber of the at least one liquid ejection device.

Clause 19: The method of clause 18 in which the least one respective characteristic associated with the at least one liquid ejection device comprises one or more than one of temperature, number of firings of the at least one liquid ejection device, firing frequency of the at least one liquid ejection device, firing duration of the at least one liquid ejection device, firing power of the at least one liquid ejection device, elapsed time since last firing of the at least one liquid ejection device, or an elapsed time since the at least one liquid ejection device last fired a predetermined number of times, taken jointly and severally in any and all permutations.

Clause 20: The method of any of clauses 16 to 19 comprising outputting the circulation signal to the respective actuator of the at least one liquid ejection device.

Clause 21: The method of any of clauses 16 to 20 comprising outputting a further temperature control signal to a respective transducer associated with a further liquid ejection device.

Clause 22: The method of clause 21 in which said temperature control signal is different to said further temperature control signal.

Clause 23: The method of clause 22 in which said temperature control signal and said further temperature control signal comprise different corresponding characteristics.

Clause 24: The method of clause 23 in which said different corresponding characteristics comprise one or more than one of temperature, number of firings of the at least one liquid ejection device, firing frequency of the at least one liquid ejection device, firing duration of the at least one liquid ejection device, firing power of the at least one liquid ejection device, elapsed time since last firing of the at least one liquid ejection device, or an elapsed time since the at least one liquid ejection device last fired a predetermined number of times, taken jointly and severally in any and all permutations.

Clause 25: The method of any of clauses 16 to 24 receiving at least one signal from a sensor associated with detecting or monitoring at least one characteristic associated with the at least one liquid ejection device.

Clause 26: The method of clause 25 comprising receiving at least one further signal from a further sensor associated with detecting or monitoring at least one characteristic associated with at least one further liquid ejection device.

Clause 27: The method of either of clauses 25 and 260, in which said one, or both, of the at least one signal and said at least one further signal are associated with a plurality of liquid ejection devices.

Clause 28: The method of any of clauses 16 to 27 outputting an ejection signal to said transducer of said liquid ejection device.

Clause 29: The method of any of clauses 16 to 28, in which the temperature control signal comprises one or more than one of a predefined signal, a pulse modulated signal, a predetermined frequency, a predetermined number of pulses, a predetermined pulse width, or first and second pulses taken jointly and severally in any and all permutations.

Clause 30: Machine-executable instructions arranged, when executed by at least one processor, to implement a controller, printer or method as any preceding clause.

Clause 31: Machine-readable storage storing machine-executable instructions of clause 30.

Clause 32: A controller configured to implement in at least one, or both, of hardware and software a method of any of clauses 16 to 29.

1. A controller to operate at least one liquid ejection device of a printhead; the liquid ejection device comprising a nozzle and an associated print liquid chamber bearing a transducer to eject print liquid from the nozzle in response to a firing signal; the print chamber being fluidically coupled to a nozzle supply channel; the at least one liquid ejection device comprising a channel coupled to the print liquid chamber and the nozzle supply channel; the channel having a respective actuator to urge print liquid through the print chamber in response to a circulation signal;
wherein the controller comprises temperature control circuitry to actuate the respective actuator using a temperature control signal to increase the temperature of print liquid in the print liquid chamber.

2. The controller of claim 1 in which the temperature control circuitry is responsive to detecting at least one characteristic associated with the at least one liquid ejection device to output the temperature control signal to increase the temperature of the print liquid in the print liquid chamber of the at least one liquid ejection device.

3. The controller of claim 2 in which the least one respective characteristic associated with the at least one liquid ejection device comprises one or more than one of temperature, number of firings of the at least one liquid ejection device, firing frequency of the at least one liquid ejection device, firing duration of the at least one liquid ejection device, firing power of the at least one liquid ejection device, elapsed time since last firing of the at least one liquid ejection device, or an elapsed time since the at least one liquid ejection device last fired a predetermined number of times, taken jointly and severally in any and all permutations.

4. The controller of claim 1 comprising circulation circuitry to output the circulation signal to the respective actuator of the at least one liquid ejection device.

5. The controller of claim 1 comprising circuitry to output a further temperature control signal to a respective transducer associated with a further liquid ejection device.

6. The controller of claim 5 in which said temperature control signal is different to said further temperature control signal.

7. The controller of claim 6 in which said temperature control signal and said further temperature control signal comprise different corresponding characteristics.

8. The controller of claim 7 in which said different corresponding characteristics comprise one or more than one of temperature, number of firings of the at least one liquid ejection device, firing frequency of the at least one liquid ejection device, firing duration of the at least one liquid ejection device, firing power of the at least one liquid ejection device, elapsed time since last firing of the at least one liquid ejection device, or an elapsed time since the at least one liquid ejection device last fired a predetermined number of times, taken jointly and severally in any and all permutations.

9. The controller of claim 1, comprising sensor circuitry to receive at least one signal from a sensor associated with detecting or monitoring at least one characteristic associated with the at least one liquid ejection device.

10. The controller of claim 9, comprising sensor circuitry to receive at least one further signal from a further sensor associated with detecting or monitoring at least one characteristic associated with at least one further liquid ejection device.

11. The controller of either of claims 9 and 10, in which said one, or both, of the at least one signal and said at least one further signal are associated with a plurality of liquid ejection devices.

12. The controller of claim 1, comprising circuitry to output an ejection signal to said transducer of said liquid ejection device.

13. The controller of claim 1, in which the temperature control signal comprises one or more than one of a predefined signal, a pulse modulated signal, a predetermined frequency, a predetermined number of pulses, a predetermined pulse width, or first and second pulses taken jointly and severally in any and all permutations.

14. A printer comprising:
a print liquid chamber bearing a transducer to eject print liquid from a nozzle in response to a firing signal,
a recirculation pump having a recirculation channel with a respective actuator to urge print liquid into the print chamber in response to a circulation signal; and
a controller having temperature control circuitry to output at least one temperature control signal to the respective actuator to increase the temperature of the print liquid urged into the print chamber.

15. A method of controlling temperature of liquid in a liquid chamber of a printer comprising a liquid ejection device of a printhead; the printhead comprising a circulation channel, coupled between the liquid chamber and a liquid supply channel, to supply liquid to the liquid chamber in response to actuating a circulation channel actuator using a respective circulation signal; the method comprising heating liquid in the circulation channel before supplying the heated liquid to the liquid chamber.
